(19) United States
(12) Patent Application Publication
(10) Pub. No.: US 2026/0066531 A1
(43) Pub. Date: Mar. 5, 2026

(54) FEED COUPLING MITIGATION STRATEGIES FOR THE REALIZATION OF ULTRAWIDEBAND FEED ARRAYS

(71) Applicant: Cheshir Industries Inc., Albuquerque, NM (US)

(72) Inventors: Nicolas Garcia, Albuquerque, NM (US); Nicholas Estes, Albuquerque, NM (US)

(21) Appl. No.: 19/310,439

(22) Filed: Aug. 26, 2025

Related U.S. Application Data
(60) Provisional application No. 63/687,943, filed on Aug. 28, 2024.

(51) Int. Cl. H01Q 1/52; H01Q 15/02; H01Q 15/14

(52) U.S. Cl. CPC H01Q 1/523; H01Q 15/02; H01Q 15/14

(57) ABSTRACT

Wideband antenna elements exhibit strong coupling when formed into an array, which normally degrades the impedance bandwidth, radiation pattern, and efficiency of the feed antennas. Various methods are provided herein to mitigate or reduce this coupling. For example, designing an array such that not all antennas support the lower frequency operation mitigates coupling at low frequencies where coupling is most significant. Alternatively, embedding the feeds into a high-refractive-index medium increases the electrical distance between feeds while the physical separation is kept constant.

### TECHNICAL FIELD

This patent application is related to obtaining a wide impedance bandwidth from a locally excited antenna feed array for lens or reflector antennas by reducing or mitigating element-to-element coupling.

### BACKGROUND

Gradient index (GRIN) lens antennas are an extremely promising alternative to conventional beamscanning antenna topologies, being both highly power-efficient and cost-effective.

FIG. 1A depicts a GRIN lens antenna, which comprises a low-directivity feed antenna (101) coupled to a GRIN lens (100).

The GRIN lens (100) collimates power radiated (102) quasi-spherically by the feed antenna (101) such that the output phase contours (103) have reduced curvature. The far-field gain of the GRIN lens antenna is substantially higher than that of the feed alone.

The GRIN lens (100) can be interpreted as either a lens that focuses an incident plane wave onto the feed (101) or a lens that transforms the feed fields (102) to a high-efficiency aperture antenna at the lens's radiating surface.

Plane wave waves incident from different angles (azimuth/elevation) on the lens are focused to different points beneath the lens. FIG. 1B shows the GRIN lens (100) of (the same lens as in FIG. 1A) focusing a non-broadside plane-wave (105) onto a feed (104) that is not located at the same position as the feed (101) of FIG. 1A.

By reciprocity, by changing the location of the feed (104) with respect to the antenna, the direction of the beam formed by collimation of the feed radiation changes in angle space (105).

By suitable design optimization, the GRIN lens (100) may be so designed that it possesses a “focal plane” (depicted in FIGS. 1C, 106). Exciting the GRIN lens (100) with a feed (108) at a different location within this plane (106) corresponds to a different collimated beam (109) angle.

Although the beam may be steered by mechanical translation of the feed (108), it is more convenient in many cases to build an array of feeds behind the lens. FIG. 1B shows such an array of feeds (107). By using switches to control the active feed(s) (108), a GRIN lens antenna may be electronically scanned like a phased array. We will refer to this architecture as a “switch-beam GRIN lens antenna”. An example resulting beam is shown (109). The switch-beam GRIN lens antenna is the architecture of interest, in the context of which the present invention is designed.

The beamforming element of the switch-beam GRIN lens antenna (the lens 100) is a purely passive device: complicated and power-hungry phase shifters/variable gain amplifiers (as in an analog phased array) and numerous ADCs/DACs (as in a digital phased array) are not required.

Therefore, switch-beam GRIN lens antennas are of great interest as low-power, low-cost, low-complexity alternatives to conventional beamformers such as analog or digital phased array antennas.

GRIN lenses are typically true time delay (TTD) optical or quasi-optical structures, like conventional homogeneous lenses.

The difference between GRIN lenses and conventional homogeneous lenses is that GRIN lenses permit the material characteristics (typically permittivity) of the lens to vary throughout the lens volume. This material variation permits the inclusion of impedance matching structures (tapers) within the lens, allowing a wideband impedance match to free space. Because of the TTD operation and impedance matching, GRIN lenses can be designed to operate across an extremely wide bandwidth. The ratio of highest frequency of operation to lowest frequency of operation of the GRIN lens itself may exceed 10:1.

The wide bandwidth operation of GRIN lenses is of special interest because phased array antennas are typically, though not necessarily, narrowband; an extremely wideband switch-beam GRIN lens antenna could potentially substantially reduce the cost and complexity of wideband beamscanning by replacing five or six equivalent phased array antennas.

Although the GRIN lens itself is extremely wideband, a switch-beam GRIN lens antenna requires that the feeding array is equivalently wideband. The design of a locally excited extremely wideband antenna array is the topic of this invention.

One aspect of the difficulty is that the feed array itself needs to have an extremely wide impedance bandwidth. The impedance bandwidth describes the range of frequencies over which an antenna will efficiently accept power. Such power is in turn either radiated by the antenna or dissipated in the antenna.

For an antenna exhibiting low conductor and dielectric losses, good matching to the source implies that most of the power available from the source is being radiated by the antenna. All else being equal, more efficient radiation from an antenna enables higher sensitivity wireless receivers and longer-range wireless transmitters. Therefore, high antenna efficiency from a matching standpoint is extremely desirable.

Often, an antenna is only considered to be working well over a given bandwidth if it accepts more than 90% of the power available from the source.

There are several methods for the design of isolated antennas that exhibit extremely wide impedance bandwidths. Beyond well-known wideband canonical antennas such as ridged horns or Vivaldi antennas, several classes of extremely wideband antennas are known to exist, including traveling wave antennas, self-complementary antennas (e.g. spiral antennas), and antennas defined only by angles (e.g. biconical antennas).

However, it is also well-known that to make extremely wideband arrays of antennas, it is not sufficient to design a wideband antenna in isolation and then construct an array by repetition of that element in a 2-D plane.

### SUMMARY

For both switch-beam GRIN lens antennas and phased arrays, the element-to-element spacing (110, 111) is small. For a given free-space wavelength “λ” and depending on the desired field of view, phased arrays must maintain element-to-element spacing (110, 111) of at most 1λ and typically no more than 0.5λ to avoid spurious emissions at grating lobes at all frequencies of operation. Since λ is smallest at the highest frequency of operation, element-to-element spacing (110, 111) is set by the highest frequency of operation. Elements are substantially electrically closer together at the low end of the array's bandwidth and coupling is generally correspondingly stronger.

While a switch-beam GRIN lens antenna does not exhibit grating lobes, the density of feed elements is in general expected to be similar to the density of elements in a phased array. Therefore, we may use insights on wideband arrays from the phased array literature.

Because of the close element-to-element spacing (110, 111), adjacent array elements in wideband antenna arrays always exhibit strong coupling, especially at the lowest operating frequencies. This coupling results in several problems. Firstly, coupling alters the input impedance of each antenna, and so each element needs to be designed in the context of an array, and the bandwidth of the antenna may be reduced. Second, power coupling to adjacent elements can be dissipated in the adjacent elements'terminations, reducing the array efficiency by reducing the amount of power radiated.

Third, the radiation pattern of the isolated antenna is altered by the presence of electrically close antennas.

It is of great interest to devise solutions to mitigate the coupling of these feed antennas for the array to operate effectively over a wide bandwidth.

This patent involves apparatus and methods for the mitigation of element-to-element coupling in locally excited wideband feed arrays for lens and reflector antennas. In one solution, the array elements are not all designed to support the lower frequencies of operation, such that nearest-neighbor coupling is reduced. In another solution, the feed antennas are all embedded in a high-refractive-index medium to increase the electrical spacing and mitigate coupling.

### BRIEF DESCRIPTION OF DRAWINGS

The foregoing and other features will be more readily apparent from the following detailed description and drawings of illustrative embodiments of the invention in which:

FIG. 1A, FIG. 1B, and FIG. 1C are illustrations of a GRIN lens antenna and array-fed GRIN lens antenna, respectively.

FIG. 2A, FIG. 2B, FIG. 2C, and FIG. 2D illustrate a 1-D “stagger-banded” feed array, in which not all elements operate across the full range of the bandwidth.

FIG. 3A and FIG. 3B illustrate embodiments of feeds fully or partially embedded in a high-refractive-index material, in which the electrical separation of the antenna feeds surpasses that in free space.

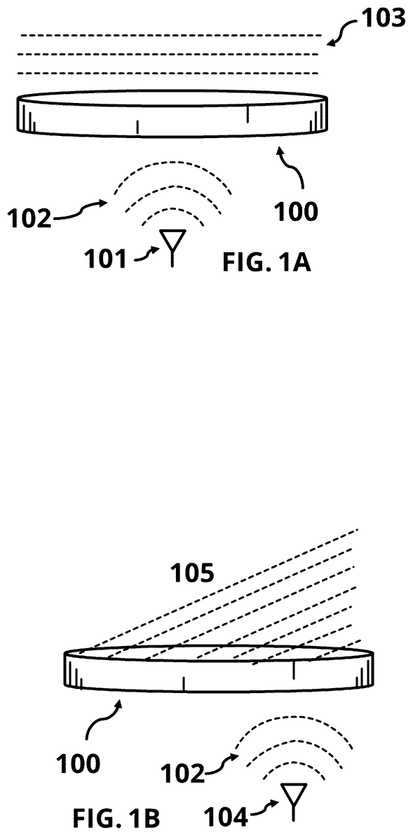

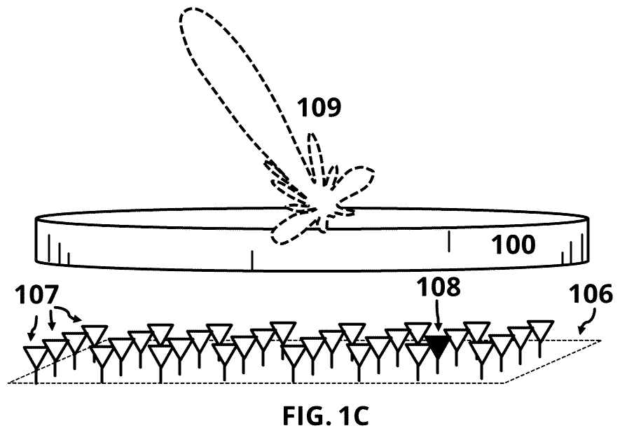

### DETAILED DESCRIPTION OF ONE OR MORE EMBODIMENTS

The techniques described herein enable reducing or mitigating the effects of element-to-element coupling in a wideband array arranged to feed a lens or reflector antenna.

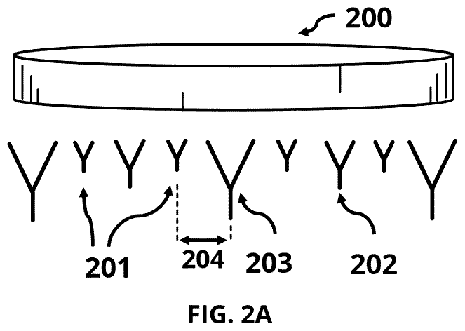

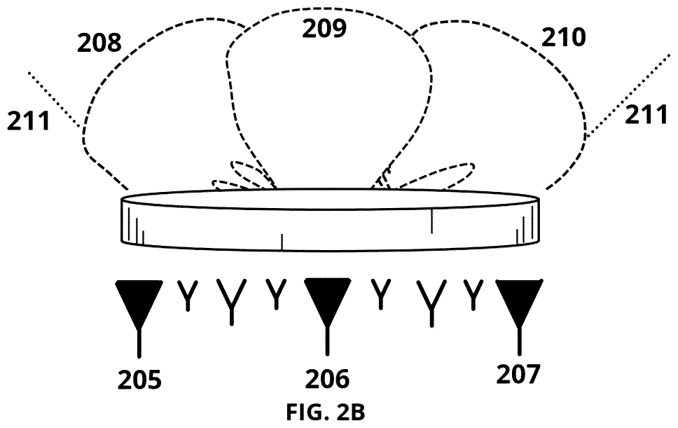

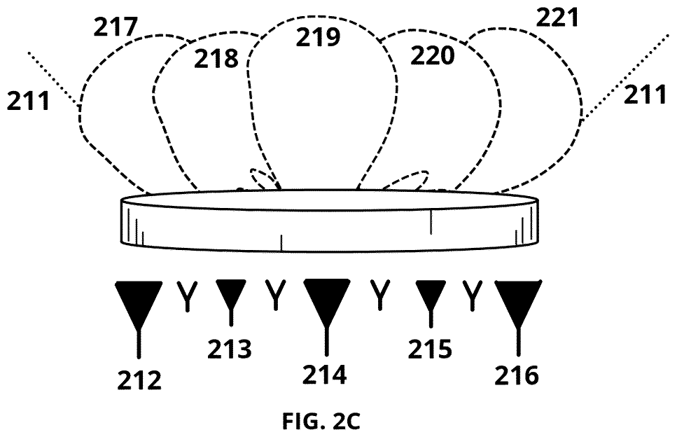

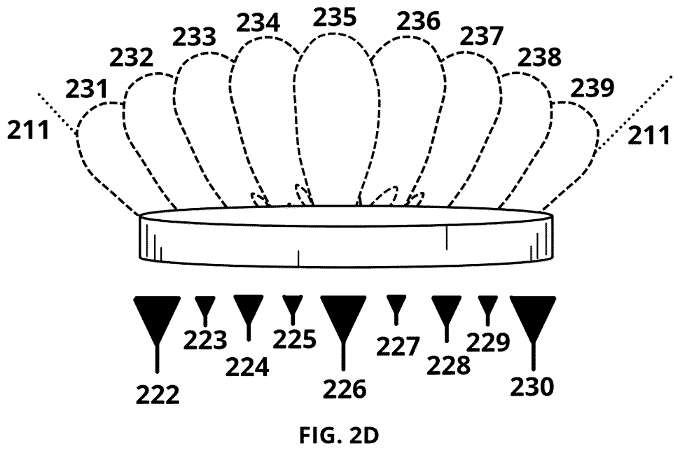

FIG. 2A illustrates one example implementation where an array of dissimilar feeds (201, 202, 203) in a “stagger-banding” configuration feed a GRIN lens (200). Although only three types of dissimilar feeds are depicted, this concept extends to an arbitrary number of dissimilar feed varieties.

The switch-beam GRIN lens antenna comprising the feeds (201, 202, 203) is assumed to be designed such that a particular field-of-view (FoV) is covered contiguously by beams that are formed by the lens antenna in conjunction with local excitation of the feed array. Thus, it is desired that addressable beams “densely” pack the FoV, with some minimum “cross-over” such that the gain of the switch-beam GRIN lens antenna is above a minimum threshold for any angle within the FoV. If the aperture efficiency of the lens antenna is maintained across the operating bandwidth, the beamwidth decreases as the frequency of operation increases. This means that a correspondingly higher number of high frequency feeds is needed for full addressability of the FoV, whereas relatively few are needed at low frequencies.

Therefore, every feed antenna (201, 202, 203), in one embodiment, operates at the maximum desired operating frequency of the GRIN lens antenna system.

However, only specific feeds in the array are enabled to access the lower frequencies or minimum frequency. Here we describe a particular nonlimiting embodiment with reference to FIG. 2A. In this example for a 5-40GHz system, every single feed antenna (201, 202, 203) is designed to operate up to 40 GHz, but only a first subset, such as one quarter (¼) of the feeds, operate across the entirety of the desired frequencies from 5-40 GHz (203). Another subset, such as a different quarter of the feeds (202), only operates from 10-40 GHz. The remaining feeds (204) are designed to operate from 20-40 GHz. The different types of feeds are interspersed with one another.

The feeds are arranged to introduce maximum spacing between the antennas operating at the lower frequencies, with priority given to the antennas operating at the lowest operating frequency. The extension to a 2-D array is straightforward.

The frequency-dependent operation of the array is depicted in FIGS. 2B, 2C, and 2D.

FIG. 2B depicts the array's operation at the lowest frequencies of the array. For the sake of illustrating an example embodiment, those are operating in a range from 5-10 GHz, although the precise operating frequency range is not intrinsic to the principles described herein. Only the feeds marked with black triangles (205, 206, 207) operate efficiently across the lowest frequency range. The beams corresponding to feeds (205, 206, 07) are (210, 209, 208), respectively. In this depiction, there are only three operating feeds, but the corresponding beams are sufficiently wide such that the FoV, (the bounds of which are indicated by the lines (211)), is still adequately covered.

FIG. 2B depicts the array's operation at the “middle” frequencies of the array (for illustration's sake here, between 10-20 GHz, although again the precise operating frequency is not intrinsic and other middle frequency ranges are possible). Only the feeds marked with black triangles (212, 213, 214, 215, 216) operate efficiently across the middle frequency range. The beams corresponding to feeds (212, 213, 214, 215, 216) are (221, 220, 219, 218, 217), respectively. Note that the feeds (212, 214, and 216) correspond to feeds (205, 206, 207) in FIG. 2B—these feeds operate across the entire range of frequencies of the array. In this depiction, there are five operating feeds at the middle frequencies, more than were available at the lowest frequencies. The beams are narrower than at the lowest frequencies. Since the number of operational feeds was increased relative to the lowest frequencies, the FoV, the bounds of which are indicated by the lines (211), is still adequately covered.

FIG. 2D depicts the array's operation at the highest frequencies of the array (for illustration's sake, 20-40 GHz, although the precise operating frequency of the highest frequencies is not intrinsic). Only the feeds marked with black triangles (222-230) operate efficiently across the upper frequency range. The beams corresponding to feeds (222-230) are (239-231), respectively. Note that the feeds (222, 226, and 230) correspond to feeds (205, 206, 207) in FIG. 2B—these feeds operate across the entire range of frequencies of the array. In a similar way, the feeds (224, 228) correspond to the feeds (213, 215) in FIG. 2C and operate at the middle and highest frequencies. In this depiction, there are nine operating feeds at the high frequencies, more than were available at the lowest or middle frequencies. The beams are even narrower than at the middle frequencies. However, since the number of operational feeds increased relative to the middle frequencies, the FoV, the bounds of which are indicated by the lines (211), is still adequately covered.

Generally, antennas operating at lower frequencies are physically larger. The inter-element spacing (204) may or may not be constant. This would normally be a problem for a phased array antenna, in which grating lobes would appear. However, it is acceptable for a switch-beam GRIN lens antenna.

The previous discussion indicates that not only are fewer lower-frequency beams required to cover the FoV as beamwidth typically increases as frequency decreases, but it is desirable to reduce the density of the low-frequency feeds (e.g. 222) and medium-frequency feeds (e.g. 224) to make efficient use of space. Therefore, certain arrangements of feeds are expected to be more conducive to implementing wideband arrays covering the FoV. Abbreviating low frequency feeds (e.g. 222) as “L”, medium frequency feeds (e.g. 224) as “M” and high frequency feeds (e.g. 223) as “H”, one potentially useful ordering of feeds is “L-H-M-H-L”, as depicted in FIG. 2A-C. Another potentially interesting ordering of feeds is “H-M-L-M-H”. Conversely, it is not expected that all arbitrary arrangements such as “L-H-L-M-M-L” will efficiently utilize array space for a given required bandwidth.

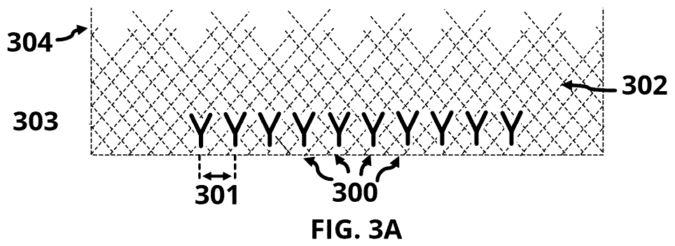

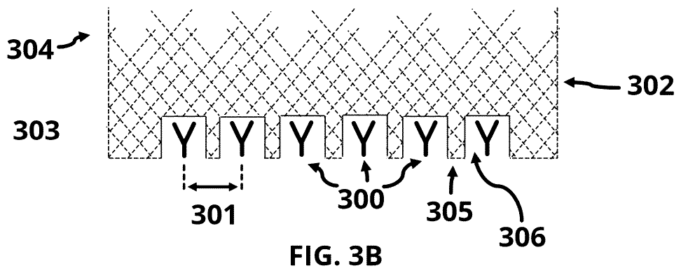

FIG. 3A illustrates other aspects for mitigating element-to-element coupling. An array of feed antennas (300) is embedded in a host material (302) with a refractive index greater than that of the medium into which the GRIN lens antenna will be radiating (303). In most cases, the medium into which the antenna will be radiating will be air with a refractive index of approximately 1.

Because the feeds are embedded in a high-refractive-index medium (302), the electrical distance between the antennas is larger than in the case where the feed antennas are implemented in air or low-refractive-index media, if the physical distance is identical in both cases (301). This reduces the mutual coupling for fixed inter-element spacing (301).

Conversely, this technique allows for feed antennas to be placed physically closer together given a maximum coupling threshold. This increased densification of feeds would allow for increased beam-overlap in the far-field and improve addressability over the GRIN lens antenna's FoV.

The difference in refractive index between the embedding medium and radiating medium (but not quite all) circumstances will produce an impedance mismatch at the material interface. An impedance matching taper (304) will usually be required to mitigate this reflection. Though FIG. 3A only depicts the impedance matching taper (304) above the feeds (300), the taper (304) may surround the entirety of the embedding medium (302).

A modified embedding solution, shown in FIG. 3B, allows host material (302) to not fully encase the feeds (300). In this embodiment, the feeds (300) are held within cavities (306) such that there are high refractive index walls (305) between the feeds. Such walls (305) may also be implemented with impedance matching structures (not depicted).

In a nonlimiting embodiment, the high refractive index material may be constructed using a material with high permeability (relative to the radiating medium).

In a nonlimiting embodiment the high refractive index material may be constructed using a material with high dielectric constant (relative to the radiating medium).

In a nonlimiting embodiment, the high refractive index material may be constructed using a material with both high dielectric constant and high permeability (relative to the radiating medium).

In a nonlimiting embodiment, the impedance matching taper (304) may be created by creating an effective medium gradient in refractive index by introducing vacancies in the host material (302).

In a separate nonlimiting embodiment, the impedance matching taper (304) and embedding material (302) are integrated into the GRIN lens antenna itself (not depicted).

The foregoing description, along with the accompanying drawings, sets forth certain specific details to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described to avoid unnecessarily obscuring descriptions of the embodiments. Additionally, the various embodiments may be methods, systems, media, or devices.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

It also should be understood that the block and system diagrams may include more or fewer elements, be arranged differently, or be represented differently. But it further should be understood that certain implementations may dictate the block and network diagrams and the number of block and network diagrams illustrating the execution of the embodiments be implemented in a particular way.

Thus, it will be understood by those skilled in the art that various changes in form and details may be made therein without departing from the legal scope of this patent as encompassed by the appended claims.

1. An antenna comprising:
a feed array and
a quasi-optical component, wherein the feed array further comprises:
a plurality of array elements; and
a structure configured to mitigate element-to-element coupling between the array elements; and further such that the feed array and quasi-optical component are configured such that radiation produced by any given element of the feed array is reshaped by the quasi-optical component to:
increase a directivity of the radiation produced by that given element; and/or
change an angular direction of a maximum of the radiation produced by that given element.

2. The antenna of claim 1 wherein the quasi-optical component is implemented using a lens.

3. The antenna of claim 2 wherein the lens is a GRIN lens.

4. The antenna of claim 1 wherein the quasi-optical component is implemented using a reflector.

5. The antenna of claim 2 wherein feed array is further configured such that
a first subset of the array elements operate across an operational frequency range; and
a second subset of the array elements do not operate with a selected portion of the operational frequency range.

6. The antenna claim 5 wherein the selected portion of the operational frequency range is one of a lowest, middle, or highest portion of the operational frequency range.

7. The antenna of claim 5 wherein the first subset of the array elements is interspersed among the second subset of the array elements.

8. The antenna of claim 4 wherein the feed array is further configured such that:
a first subset of the array elements operate across an operational frequency range; and
a second subset of the array elements do not operate with a selected portion of the operational frequency range.

9. The antenna array of claim 8 wherein the selected portion of the operational frequency range is one of a lowest, middle, or highest portion of the operational frequency range.

10. The antenna array of claim 8 wherein the first set of array elements is interspersed among the second set of array elements.

11. The antenna of claim 2 additionally comprising:
a high refractive-index medium within which are disposed one or more of the array elements.

12. The antenna of claim 11 in which the refractive index medium is implemented using a GRIN material.

13. The antenna of claim 4 additionally comprising:
a high refractive-index medium within which are disposed one or more of the array elements.

14. The antenna of claim 13 wherein the high refractive index medium is implemented using a GRIN material.
